(19) United States
(12) Patent Application Publication
(10) Pub. No.: US 2010/0305257 A1
(43) Pub. Date: Dec. 2, 2010

(54) THERMOPLASTIC POLYMER COMPOSITIONS COMPRISING HIGH-FLUIDITY POLYAMIDES

(76) Inventors: Lise Trouillet-Fonti, Villette-de-Vienne (FR); Marco Amici, Perugia (IT); Christophe Lapierre, Jonage (FR)

Correspondence Address: BUCHANAN, INGERSOLL & ROONEY PC, POST OFFICE BOX 1404, ALEXANDRIA, VA, 22313-1404, US

(21) Appl. No.: 12/738,445

(22) PCT Filed: Oct. 17, 2008
(86) PCT No.: PCT/EP08/64041

§ 371 Date: Jul. 12, 2010

(30) Foreign Application Priority Data
Oct. 19, 2007 (FR) 0707329

(51) Int. Cl. C08K 3/32; C08L 77/00; C08K 3/22; C08K 3/26; C08K 3/08; C08K 3/34; C08K 3/36; C08K 3/40; B29C 45/00

(52) U.S. Cl. 524/413; 524/606; 524/430; 524/425; 524/440; 524/445; 524/447; 524/449; 524/451; 524/448; 264/328.1

(57) ABSTRACT

Thermoplastic polymer compositions contain high-fluidity polyamides and have an excellent compromise in terms of properties, in particular mechanical properties and a high fluidity in the molten state; such compositions contain at least one high-fluidity polyamide and a high filler content, such as glass fibers.

The present invention relates to a polyamide-based thermoplastic polymer composition that exhibits an excellent balance between its properties, in particular its mechanical properties, and a high melt flow. The invention relates in particular to a composition comprising at least one high-fluidity polyamide and a high proportion of fillers, such as glass fibers; and also to a process for the manufacture of such a composition.

### PRIOR ART

Among the properties that it is often desired to control in the case of a thermoplastic intended to be formed by techniques such as injection molding, gas-injection molding, extrusion and extrusion-blow molding, mention is made of stiffness, impact strength, dimensional stability, in particular at a relatively high temperature, low post-forming shrinkage, a capacity for coating by various processes, surface appearance and density. These properties can be controlled, within certain limits, through the choice of a polymer or through the addition to the polymer of compounds of various natures. In the latter case, the term polymeric compositions is used. The choice of a material for a given application is generally guided by the required level of performance with respect to certain properties and by its cost. The aim is always to obtain new materials that can meet a specification in terms of performance and/or cost. Polyamide is, for example, a material that is widely used, in particular in the sector of the automotive industry.

Polyamide is a polymer which is chemically resistant, which is stable at high temperatures and which may be blended with various types of fillers in order to modify the properties thereof. It is possible, for example, to improve its mechanical properties by adding fibrous or non-fibrous reinforcing fillers.

In order to obtain high-performance polyamide materials, it is possible, in theory, to add a high proportion of reinforcing fillers to the polyamide composition. However, at high reinforcing filler contents, the articles have very poor surface appearances, and the polyamide compositions have a rheological behavior that is not very suitable for the forming processes of interest, especially injection molding. Furthermore, such compositions are difficult to process and it is often necessary to increase the pressure and/or the temperature in said forming processes.

Furthermore, it appears that polyamide-based compositions comprising high reinforcing filler contents will result in molded articles being obtained that have a high shrinkage anisotropy, especially due to the orientation of the fillers, such as glass fibers.

Furthermore, it is difficult to produce molded articles that have very good performances in terms of mechanical properties, even with a high level of reinforcing fillers, since the high proportion of these fillers will induce zones of mechanical brittleness at the locations where the flows of material meet inside the molds, during the molding process. These zones are referred to as the knit lines of the material fronts of the molded parts.

There is thus a need to develop a polyamide composition that has a high level of reinforcing fillers but that does not have the drawbacks mentioned previously.

### INVENTION

The Applicant has brought to light polyamide compositions that exhibit increased melt flow and equivalent or superior mechanical properties, compared to conventional polyamide compositions, and that make it possible to produce articles that have an excellent surface appearance, when these articles comprise a high level of fillers. In addition, it appears that these compositions are easy to process in the forming processes of interest, especially injection molding.

Furthermore, it is observed that articles molded from the polyamide-based compositions of the invention have a limited, almost isotropic shrinkage, which is capable of reducing the warping of said articles. Furthermore, the combination of high-fluidity polyamides and of the presence of high reinforcing filler contents enables articles to be molded for which the knit line of the material fronts of the molded parts has a good mechanical strength.

Thus one subject of the invention is a composition comprising at least:
a) a polyamide of PA-6,6 type obtained by a process of polymerization of monomers of polyamide PA-6,6 in the presence, in addition, of monofunctional and/or difunctional compounds comprising carboxylic acid or amine functional groups;
b) a content of reinforcing fillers greater than or equal to 45% by weight relative to the total weight of the composition;
c) said composition having an apparent melt viscosity, in Pa·s, according to the following relationships:

η100≦30(X)−800

η1000≦11(X)−280

in which η is the apparent melt viscosity of the polyamide composition measured at a temperature of 275° C.; either at a shear rate of 100 s⁻¹, η100, or at a shear rate of 1000 s⁻¹, η1000; and X corresponds to the weight proportion of reinforcing fillers relative to the total weight of the composition.

The polyamide a) is a thermoplastic polyamide of type PA-6,6, that is to say a polyamide obtained at least from adipic acid and hexamethylenediamine or salts thereof such as hexamethylenediamine adipate, which may optionally comprise other polyamide monomers.

The polyamide according to the invention may have a molecular weight Mₙ between 3000 and 17 000 g/mol, preferably between 11 000 and 17 000, more preferably between 11 000 and 15 000 and more preferably still between 12 000 and 14 500.

It may also have a polydispersity index (D=M_{w}/Mₙ) of less than or equal to 2.

The polymerization of the polyamide of the invention is especially carried out according to the conventional operating conditions for polymerization of polyamides, in continuous mode or batch mode.

Such a polymerization process may comprise, briefly:
heating the blend of monomers, and polyfunctional (i) and monofunctional (ii) compounds, with stirring and under pressure;
holding the blend under pressure and temperature for a given time, with removal of water vapor via a suitable device, then depressurization and holding for a given time at a temperature above the melting point of the blend, especially under autogenous pressure of water vapor, under nitrogen or under vacuum, in order thus to continue the polymerization by removal of the water formed.

At the end of polymerization, the polymer can be cooled, advantageously with water, and extruded in the form of rods. These rods are cut up in order to produce granules.

According to the invention, the polyamide is manufactured by addition, during polymerization, especially at the start of the polymerization, of polyamide PA-6,6 monomers, in the presence, moreover, of difunctional and/or monofunctional compounds. These difunctional and/or monofunctional compounds have amine or carboxylic acid functional groups capable of reacting with the monomers of the polyamide. The difunctional compounds may have the same amine or carboxylic acid functionality. The amine functional groups may be primary and/or secondary amine functional groups.

The difunctional and/or monofunctional compounds used are agents that modify the chain length of the polyamides and make it possible to obtain polyamides that have a melt flow index greater than or equal to 10 g/10 min according to the standard ISO 1133 measured at a temperature of 275° C. with a load of 325 g, preferably between 10 and 50 g/10 min, more preferably between 15 and 50 g/10 min and more preferably still between 20 and 40 g/10 min.

It is possible to use, at the start of, during or at the end of the polymerization all types of aliphatic or aromatic monocarboxylic or dicarboxylic acids, or all types of aliphatic or aromatic monoamine or diamine amines. Use may especially be made, as a monofunctional compound, of n-dodecylamine and 4-amino-2,2,6,6-tetramethylpiperidine, acetic acid, lauric acid, benzylamine, benzoic acid and propionic acid. Use may especially be made, as a difunctional compound, of adipic acid, terephthalic acid, isophthalic acid, sebacic acid, azelaic acid, dodecanedioic acid, decanedioic acid, pimelic acid, suberic acid, fatty acid dimers, di(β-ethylcarboxy)cyclohexanone, hexamethylenediamine, 5-methylpentamethylenediamine, meta-xylylenediamine, butanediamine, isophoronediamine, 1,4-diaminocyclohexane and 3,3′,5-trimethylhexamethylene-diamine.

It is also possible to use an excess of adipic acid or an excess of hexamethylenediamine for the production of a polyamide of type PA-6,6 having a high melt flow.

Preferably, the proportion of terminal acid groups is different from the proportion of terminal amine groups, in particular at least two times higher or lower. The amounts of terminal amine groups (TAG) and/or terminal acid groups (TCG) are determined by potentiometric assays after dissolution of the polyamide. One method is, for example, described in “Encyclopedia of Industrial Chemical Analysis”, volume 17, page 293, 1973.

In particular, a composition that has an apparent melt viscosity, in Pa·s, in accordance with the following relationships:

η1100≦20(X)−400

η1000≦9(X)−240

is preferred.

A composition that has an apparent melt viscosity, in Pa·s, in accordance with the following relationships:

η100≦20(X)−450

η1000≦7(X)−160

is more particularly preferred.

As reinforcing filler, or bulking filler, mention may especially be made of those selected from the group comprising fibrous fillers, such as glass fibers, carbon fibers, natural fibers, and/or non-fibrous fillers. Mention may be made, as natural fibers, of hemp and linen. Among the non-fibrous fillers, mention may especially be made of all particulate fillers, lamellar fillers and/or exfoliable or non-exfoliable nanofillers such as alumina, carbon black, clays, zirconium phosphate, kaolin, calcium carbonate, copper, diatomaceous earths, graphite, mica, silica, titanium dioxide, zeolites, talc, wollastonite, polymeric fillers such as, for example, dimethacrylate particles, beads of glass or glass powder.

It is entirely possible, according to the invention, for the composition to comprise several types of reinforcing fillers. Preferably, the most widely used filler may be glass fibers, of the chopped type, especially having a diameter between 7 and 14 μm. These fillers may have an average length between 0.1 and 5 mm. These fillers may have a surface size that ensures the mechanical adhesion between the fibers and the polyamide matrix, especially under critical environmental conditions, such as for example in contact with engine fluids.

The composition may especially comprise from 50 to 80% by weight of reinforcing fillers, relative to the total weight of the composition.

Considering the high performances of the polyamide composition according to the invention, it is not especially useful for it to comprise impact modifiers. Thus, preferably, the composition according to the invention does not comprise impact modifiers, especially those having an elastomeric base comprising functional groups that are reactive with the polyamide.

The composition may comprise, besides the modified polyamide of the invention, one or more other polymers, preferably polyamides or copolyamides.

The composition according to the invention may also comprise additives customarily used for the manufacture of polyamide compositions. Thus, mention may be made of lubricants, flame retardants, plasticizers, nucleating agents, catalysts, light and/or heat stabilizers, antioxidants, antistatic agents, dyes, matifying agents, molding aids or other conventional additives.

These fillers and additives may be added to the modified polyamide via the standard means suitable for each filler or additive, such as for example during the polymerization or by melt blending.

The apparent melt viscosity of the polyamide composition according to the present invention may be measured according to the standard ISO 11443, in particular by using a Göttfert Rheograph 2002 capillary rheometer. It is possible, for example, to use a capillary with a length of 30 mm and a diameter of 1 mm, with a piston having a diameter of 12 mm; and, for example, to carry out the measurements with samples that have a residual moisture of less than 0.06%.

The thermoplastic compositions are generally obtained by blending the various compounds that are incorporated into the composition, the thermoplastic compounds being in molten form. This is carried out at a higher or lower temperature and at a higher or lower shear stress depending on the nature of the various compounds. The compounds may be introduced simultaneously or successively. Generally, an extrusion device is used in which the material is heated, subjected to a shear stress, and transported. Such devices are fully known to a person skilled in the art.

According to a first embodiment, all the compounds are melt blended during a single operation, for example during an extrusion operation. It is possible, for example, to carry out a blending of granules of the polymer materials, introduce them into the extrusion device in order to melt them and subject them to a greater or lesser shear.

It is possible, according to particular embodiments, to produce molten or non-molten premixes of some of the compounds before preparation of the final composition.

The composition according to the invention, when it is prepared using an extrusion device, is preferably packaged in the form of granules. The granules are intended to be formed using processes that involve melting in order to obtain articles. The articles are thus constituted of the composition. According to one customary embodiment, the modified polyamide is extruded in the form of rods, for example in a twin-screw extrusion device, which rods are then cut up into granules. The molded parts are then produced by melting the granules produced above and feeding the composition in the molten state into forming devices, especially injection-molding devices.

The composition according to the invention may be used for any plastic-forming process, such as for example the injection-molding process. The present invention thus also relates to an injection-molding process in which a composition according to the invention is introduced into an injection-molding device and the molding operation is carried out.

Said process may especially be carried out in the absence, or else in the presence, of a supercritical fluid in order to produce microcellular articles.

The use of the compositions according to the invention is particularly advantageous within the context of the manufacture of articles for the motor vehicle or electrical industry, in particular for the molding of parts that are fine, of large size and/or have complex geometry, such as for example car fenders or circuit breakers.

Specific terms are used in the description so as to facilitate the understanding of the principle of the invention. It should nevertheless be understood that no limitation of the scope of the invention is envisaged by the use of these specific terms. The term “and/or” includes the meanings and, or, and also all the other possible combinations of the elements connected to this term.

Other details or advantages of the invention will appear more clearly in light of the examples below, given solely by way of indication.

### EXPERIMENTAL SECTION

The compounds used are the following:
PA1: Polyamide 6,6 having an MFI of 4.5 g/10 min (according to the standard ISO 1133 measured at 275° C., under a load of 325 g) and a VI of 135 ml/g (according to the standard ISO 307). Contents of the following terminal groups: TAG=50 meq/kg, TCG=80 meq/kg.
PA2: Polyamide 6,6 having an MFI of 30 g/10 min and a VI of 98 ml/g. Contents of the following terminal groups: TAG=30 meq/kg, TCG=93 meq/kg. Obtained by addition, at the start of polymerization, of 0.5 mol % of acetic acid.
PA3: Polyamide 6,6 having an MFI of 27 g/10 min and a VI of 101 ml/g. Contents of the following terminal groups: TCG=65 meq/kg, TAG=50 meq/kg. Obtained by addition, at the start of polymerization, of 0.6 mol % of acetic acid and 0.4 mol % of hexamethylenediamine.
Glass fibers: Vetrotex 995.
Heat stabilizer: CuI and KI (respectively, <0.02% and <0.1% by weight fraction).
Additive: EBS wax, and nigrosine sold under the name 54/1033 by Ferroplast.

The compositions are prepared by melt blending, using a twin-screw extruder of WERNER and PFLEIDERER ZSK type, polyamides, 50% by weight of glass fibers and 1.5% by weight of additives. The extrusion conditions are the following: temperature: between 240 and 280° C.: rotation speed: between 200 and 300 rpm, throughput: between 25 and 60 kg/h.

The results are given in table 1:

TABLE 1

| Compositions | C1 | 1 | 2 |
|---|---|---|---|
| PA 1 | 48.5 | | |
| PA 2 | | 48.5 | |
| PA 3 | | | 48.5 |
| Different additives (CuI, KI, wax, | 1.5 | 1.5 | 1.5 |
| nigrosine, etc.) | | | |
| Glass fibers | 50 | 50 | 50 |
| Total | 100 | 100 | 100 |
| Ash content ISO 3451/1A 30 min at | 49.8 | 50.1 | 50.1 |
| 750° C. (%) | | | |
| VI ISO 307 (ml/g) | 135 | 98 | 101 |
| Melting point ISO 11357-3 (° C.) | 263.8 | 264.3 | 265.63 |
| Crystallization temperature | 223.5 | 225.5 | 225.28 |
| ISO 11357-3 (° C.) | | | |
| Notched Charpy impact strength | 13.7 | 14.4 | 14.1 |
| ISO 179/1eA (kJ/m²) | | | |
| Unnotched Charpy impact strength | 93.8 | 102.8 | 99.0 |
| ISO 179/1eU (kJ/m²) | | | |
| Unnotched Charpy impact strength | 51.2 | 62.1 | 59.8 |
| ISO 179/1eU (kJ/m²) after 1000 h at 150° C. | | | |
| Tensile strength ISO 527 (N/mm²) | 221 | 248 | 245 |
| Tensile elongation ISO 527 (%) | 2.7 | 2.9 | 2.9 |
| Tensile modulus ISO 527 (N/mm²) | 16.5 | 16.7 | 16.9 |
| η100 (Pa · s) | 1030 | 452 | 513 |
| η1000 (Pa · s) | 434 | 138 | 195 |
| Spiral test (cm) | 19 | 27 | 25 |
| Parallel shrinkage (%) | 0.43 | 0.34 | 0.33 |
| Perpendicular shrinkage (%) | 0.68 | 0.42 | 0.47 |
| Delta shrinkage (%) | 0.25 | 0.08 | 0.14 |
| Tensile strength of the knit line (MPa) | 59 | 108 | 98 |
| Percentage tensile strength of the | 24 | 43 | 40 |
| knit line (%) | | | |
| Surface appearance | bad | good | good |

The capillary rheometer analysis was carried out according to the standard ISO 11443 on dry granules using a GÖTTFERT RHEOGRAPH 2002 rheometer, with, in particular, a transducer of 1000 bar, a Roundhole type capillary of 30 mm×1 mm in diameter, with a piston of 12 mm in diameter and a speed (mm/s): 0.01; 0.02; 0.05; 0.1; 0.2; 0.5; 1.0; 2.0; 5.0.

The melting temperature was measured according to the standard ISO 11357-3 (“METTLER DSC 20” DSC, with a temperature ramp of 10° C./min).

The spiral test makes it possible to quantify the fluidity of the compositions by melting the granules and by injecting them into a spiral-shaped mold having a rectangular cross section with a thickness of 2 mm and a width of 4 cm, in a BM-Biraghi 85T press at a barrel temperature of 275° C., a mold temperature of 80° C. and with a maximum injection pressure of 130 bar hydraulic, which corresponds to an injection time of around 0.4 seconds. The result is expressed as the length of mold correctly filled by the composition.

The shrinkage is measured after obtaining sheets that were injection-molded at a side point, at a relative humidity of less than 0.2%, having dimensions of 100×100×3.4 mm, stored in an airtight container at 23° C. for 24 hours at least; and evaluated dry at 23° C./50% RH with a micrometer to within 0.01 mm.

The injection molding of these sheets was carried out on a DEMAG 80T press at a barrel temperature of 280° C., a mold temperature of 80° C. and with a hold pressure of 20 bar hydraulic for 15 seconds for an injection time of around 0.55 seconds.

The shrinkage is the difference between the dimension of the mold and the measurement of the sheet/dimension of the mold, expressed as a percentage.

The tensile strength of the knit line of the material fronts is measured according to the standard ISO 527 on dumbbell type test specimens injection molded with a mold comprising an injection point positioned at each end of its length; this point having a slit aperture gating.

It is thus observed that the molded articles obtained according to the invention have an excellent balance between melt flow and mechanical properties while having a good surface appearance. Furthermore, the compositions according to the invention make it possible to manufacture articles that have an isotropic shrinkage compared to highly-filled compositions that comprise a polyamide having a standard rheology. It also appears that the compositions according to the invention allow articles to be produced for which the knit line has a good tensile strength.

1.-10. (canceled)

11. An enhanced melt flow thermoplastic polymer composition comprising at least one high-fluidity thermoplastic polyamide, an amount of reinforcing fillers greater than or equal to 45% by weight relative to the total weight of the composition and said composition having an apparent melt viscosity, in Pa·s, in accordance with the following relationships:
η100≦30(X)−800
η1000≦11(X)−280
in which η is the apparent melt viscosity of the polyamide composition measured at a temperature of 275° C.; either at a shear rate of 100 s⁻¹, η100, or at a shear rate of 1000 s⁻¹, η1000; and X corresponds to the weight proportion of reinforcing fillers relative to the total weight of the composition.

12. The thermoplastic polymer composition as defined by claim 11, comprising:
a) a PA-6,6 polyamide produced by polymerization of PA-6,6 polyamide monomers in the presence, in addition, of monofunctional and/or difunctional compounds which comprise carboxylic acid or amine functional groups;
b) a content of reinforcing fillers greater than or equal to 45% by weight relative to the total weight of the composition; and
c) said composition having an apparent melt viscosity, in Pa·s, according to the following relationships:
η100≦30(X)−800
η1000≦11(X)−280
in which ηis the apparent melt viscosity of the polyamide composition measured at a temperature of 275° C.; either at a shear rate of 100 s⁻¹, η100, or at a shear rate of 1000 s⁻¹, η1000; and X corresponds to the weight proportion of reinforcing fillers relative to the total weight of the composition.

13. The thermoplastic polymer composition as defined by claim 12, wherein the polyamide has a melt flow index greater than or equal to 10 g/10 min according to the standard ISO 1133 measured at a temperature of 275° C. with a load of 325 g.

14. The thermoplastic polymer composition as defined by claim 12, wherein the polyamide has a molecular weight Mₙ ranging from 3,000 to 17,000 g/mol.

15. The thermoplastic polymer composition as defined by claim 12, wherein the reinforcing fillers are selected from the group consisting of fibrous and/or non-fibrous fillers.

16. The thermoplastic polymer composition as defined by claim 12, wherein the reinforcing fillers comprises fibrous fillers selected from the group consisting of glass fibers, carbon fibers, and/or natural fibers.

17. The thermoplastic polymer composition as defined by claim 12, wherein the reinforcing fillers comprise non-fibrous fillers selected from the group consisting of particulate fillers, lamellar fillers and/or exfoliable or non-exfoliable nanofillers of alumina, carbon black, clays, zirconium phosphate, kaolin, calcium carbonate, copper, diatomaceous earths, graphite, mica, silica, titanium dioxide, zeolites, talc, wollastonite, polymeric fillers, beads of glass or glass powder.

18. The thermoplastic polymer composition as defined by claim 12, wherein the content of reinforcing fillers ranges from 50% to 80% by weight of reinforcing filler, relative to the total weight of the composition.

19. The thermoplastic polymer composition as defined by claim 12, devoid of impact modifiers.

20. An injection-molding process in which a thermoplastic polymer composition as defined by claim 11 is introduced into an injection-molding apparatus and therein molding said composition.

21. A shaped article molded from a thermoplastic polymer composition as defined by claim 11.

22. Granules comprising molded shaped articles as defined by claim 21.

23. The thermoplastic polymer composition as defined by claim 11, comprising a thermoplastic polyamide having a polydispersity index of less than or equal to 2.

24. A molded, shaped article as defined by claim 21, exhibiting essentially isotropic shrinkage.
